(19) United States
(12) Patent Application Publication
(10) Pub. No.: US 2021/0102055 A1
(43) Pub. Date: Apr. 8, 2021

(54) POLYMER COMPOSITION FOR 3D PRINTING, MATERIAL, METHOD AND MOLDED ARTICLE THEREOF

(71) Applicant: TSRC Corporation, Kaohsiung City (TW)

(72) Inventors: Hsi-Hsin Shih, Kaohsiung City (TW); Yun-Shiuan Yeh, Kaohsiung City (TW)

(21) Appl. No.: 17/025,982

(22) Filed: Sep. 18, 2020

Related U.S. Application Data
(60) Provisional application No. 62/902,589, filed on Sep. 19, 2019.

(51) Int. Cl. C08L 25/10; B29C 64/153; B29C 64/118

(52) U.S. Cl. CPC C08L 25/10; B29K 2025/08; B29C 64/118; B29C 64/153

(57) ABSTRACT

A polymer composition for 3D printing is provided, wherein the polymer composition comprises a polymer including a vinyl aromatic based block copolymer composed of vinyl aromatic monomer and conjugated diene monomer, a vinyl aromatic monomer content of the vinyl aromatic based block copolymer is less than 25% by weight, and the polymer does not contain polyolefin, polylactide, polycarbonate, polyamide, polymethylmethacrylate, poly(methyl acrylate), polyvinylchloride, poly(vinylidene chloride), polyester, vinyl acetate copolymer and styrene-based resin.

### CROSS REFERENCE TO RELATED APPLICATION

This application claims the benefit of priority of U.S. Provisional Application Ser. No. 62/902,589 filed on Sep. 19, 2019 and entitled “polymer composition for 3D printing”, the entirety of which is incorporated herein by reference and assigned to the assignee herewith.

### BACKGROUND OF THE INVENTION

### Field of the Invention

The present invention relates to a polymer composition and, in particular, to a polymer composition containing a vinyl aromatic based block copolymer for 3D printing.

### Description of the Prior Art

3D printing, also known as additive manufacturing, is a rapid molding technology. The printing machine constructs a model having the characteristic details of a 3D image in a manner of high-precision stacking layer upon layer according to the image under the control of the computer. According to the type of raw material and the process of molding, 3D printing can be divided into more than ten different technologies such as Fused Deposition Modeling (FDM), Stereolithography (SLA) and Selective Laser Sintering (SLS). In the FDM method, the filamentous soft material is placed in the extrusion head, and the extrusion head is heated to melt the material. The extrusion head selectively extrudes the molten material on the working platform under the control of a computer, and then the material is cooled and stacked layer upon layer to form a stereomolded body. The difference of the printing way between the 3D printing machine of pellet extrusion type and the FDM is the type of feed material. The 3D printing machine of pellet extrusion type can directly use raw materials in pellet form to print without drawing the materials into a thread (filament) form.

The materials for 3D printing generally include polylactic acid (PLA), acrylonitrile-butadiene-styrene copolymer (ABS), Nylon or thermoplastic elastomer (TPE), among which most types of commercially available TPE materials are thermoplastic polyurethane (TPU), and it is rare to use the series formulations of Styrenic Block Copolymer (SBC) as printing materials. There are known technologies that use vinyl aromatic/diene block copolymers as the materials for 3D printing, such as those described in US20160319122A1, US20160319120A1, and CN106467650A. However, these materials still have various deficiencies.

### SUMMARY OF THE INVENTION

The present invention has discovered that conventional 3D printing materials containing a vinyl aromatic/diene block copolymer are complicated in their compositions and easily lead to poor compatibility problems for the need to be blended with other types of polymers. In view of this, the present invention provides a 3D printing material which has a relatively simple composition. More preferably, the present invention provides a 3D printing material and method, which has not only a relatively simple composition, but also a more convenient printing process.

According to one embodiment, the present invention provides a polymer composition for 3D printing, which comprises a polymer including a vinyl aromatic based block copolymer composed of a vinyl aromatic monomer and a conjugated diene monomer, and the vinyl aromatic based block copolymer has a vinyl aromatic monomer content of less than 25 wt %, preferably less than 20 wt % or more preferably less than 15 wt %, wherein the polymer does not contain a polyolefin, a polylactide, a polycarbonate, a polyamide, a polymethylmethacrylate (PMMA), a poly(methyl acrylate) (PMA), a polyvinylchloride, a polyvinylidene chloride, a polyester, a vinyl acetate copolymer and a styrene-based resin.

According to another embodiment, the present invention provides a polymer composition as described above, wherein the vinyl aromatic monomer is selected from styrene, methyl styrene and all its isomers, ethyl styrene and all its isomers, tert-butyl styrene and all its isomers, dimethyl styrene and all its isomers, methoxystyrene and all its isomers, cyclohexyl styrene and all its isomers, vinyl biphenyl, 1-vinyl-5-hexylnaphthalene, vinyl naphthalene, vinyl anthracene, 2,4-diisopropylstyrene, 5-tert-butyl-2-methylstyrene, divinylbenzene, trivinylbenzene, divinylnaphthalene, tert-butoxystyrene, 4-propylstyrene, 4-dodecylstyrene, 2-ethyl-4-benzylstyrene, 4-(phenylbutyl)styrene, N-4-vinylphenyl-N,N-dimethylamine, (4-vinyl phenyl) dimethylaminoethyl ether, N,N-dimethylaminomethylstyrene, N,N-dimethylaminoethylstyrene, N,N-diethylaminomethylstyrene, N,N-diethylaminoethylstyrene, vinyl xylene, vinyl pyridine, diphenyl ethylene, 2,4,6-trimethylstyrene, α-methyl-2,6-dimethylstyrene, α-methyl-2,4-dimethylstyrene, β-methyl-2,6-dimethylstyrene, β-methyl-2,4-dimethylstyrene, indene, diphenylethylene containing a tertiary amino group such as 1-(4-N,N-dimethylaminophenyl)-1-phenylethylene and a combination thereof; and the conjugated diene monomer is selected from 1,3-butadiene, 1,3-pentadiene, 1,3-hexadiene, 1,3-heptadiene, 2-methyl-1,3-butadiene (isoprene), 2-methyl-1,3-pentadiene, 2-hexyl-1,3-butadiene, 2-phenyl-1,3-butadiene, 2-phenyl-1,3-pentadiene, 2-p-tolyl-1,3-butadiene, 2-benzyl-1,3-butadiene, 3-methyl-1,3-pentadiene, 3-methyl-1,3-hexadiene, 3-butyl-1,3-octadiene, 3-phenyl-1,3-pentadiene, 4-methyl-1,3-pentadiene, 1,4-diphenyl-1,3-butadiene, 2,3-dimethyl-1,3-butadiene, 2,3-dimethyl-1,3-pentadiene, 2,3-dibenzyl-1,3-butadiene, 4,5-diethyl-1,3-octadiene, myrcene and a combination thereof.

According to another embodiment, the present invention provides a polymer composition as described above, wherein the vinyl aromatic based block copolymer is an unhydrogenated copolymer, a partially hydrogenated copolymer, or a fully hydrogenated copolymer.

According to another embodiment, the present invention provides a polymer composition as described above, wherein the vinyl aromatic based block copolymer is selected from Styrene-Ethylene-Butylene-Styrene block copolymer (SEBS), Styrene-Ethylene-(Ethylene-Propylene)-Styrene block copolymer (SEEPS), Styrene-Ethylene-Propylene-Styrene block copolymer (SEPS), Styrene-Butadiene-Styrene block copolymer (SBS), Styrene-Isoprene-Styrene block copolymer (SIS), Styrene-(Isoprene/Butadiene)-Styrene block copolymer (S-(I/B)-S) and a combination thereof.

According to another embodiment, the present invention provides a polymer composition as described above, wherein the polymer consists of the vinyl aromatic based block copolymer.

According to another embodiment, the present invention provides a polymer composition as described above, wherein the weight average molecular weight of the vinyl aromatic based block copolymer ranges from 50,000 to 500,000, preferably 70,000 to 350,000; and the weight average molecular weight of the vinyl aromatic block of the vinyl aromatic based block copolymer ranges from 4,000 to 7,000, preferably 6,000 to 7,000, more preferably 4,000 to 5,000, and most preferably 5,200 to 5,800.

According to another embodiment, the present invention provides a polymer composition as described above, which further comprises a processing aid, wherein the content of the processing aid is not greater than four times the content of the vinyl aromatic based block copolymer.

According to another embodiment, the present invention provides a polymer composition as described above, wherein the processing aid is selected from processing oils, which are aromatic hydrocarbon oil, naphthenic oil, paraffin oil and a combination thereof.

According to another embodiment, the present invention provides a polymer composition as described above, wherein the content of the processing aid is 50 to 80 wt %, preferably 55 to 75 wt %, more preferably 60 to 75 wt %, and most preferably 65 to 75 wt % of the total weight of the polymer composition.

According to another embodiment, the present invention provides a polymer composition as described above, wherein the polymer composition does not contain a processing aid.

According to another embodiment, the present invention provides a polymer composition as described above, which further comprises an auxiliary agent, wherein the auxiliary agent is selected from a colorant, an inorganic filler, an antioxidant and a combination thereof.

According to one embodiment, the present invention provides a material for 3D printing made from the polymer composition as described above.

According to another embodiment, the present invention provides a material as described above, which has a pellet, powder, thread or filament form.

According to another embodiment, the present invention provides a material as described above, wherein a test piece formed by injecting the material has a hardness of less than or equal to 70 (shore A), preferably 35-70 (shore A), measured according to the ASTM-D2240 method.

According to another embodiment, the present invention provides a material as described above, wherein a test piece formed by injecting the material has a hardness of less than or equal to 20 (shore A), preferably less than or equal to 15 (shore A), more preferably less than or equal to 5 (shore A), measured according to the ASTM-D2240 method.

According to one embodiment, the present invention provides a method for 3D printing, comprising the following steps: step (1): providing the material as described above; and step (2): 3D printing the material.

According to another embodiment, the present invention provides a method as described above, wherein the step (2) further comprises using Fused Deposition Modeling (FDM) for the 3D printing.

According to another embodiment, the present invention provides a method as described above, wherein the step (2) further comprises using Selective Laser Sintering (SLS) for the 3D printing.

According to another embodiment, the present invention provides a method as described above, wherein the step (2) further comprises using Multi Jet Fusion (MJF) for the 3D printing.

According to another embodiment, the present invention provides a method as described above, wherein the step (2) further comprises printing at a temperature of lower than 250° C., preferably between 230° C. and 250° C.

According to another embodiment, the present invention provides a method as described above, wherein the step (2) further comprises printing at a temperature of lower than 200° C., preferably between 130° C. and 150° C.

According to one embodiment, the present invention provides a molded article manufactured from the material as described above by 3D printing.

According to one embodiment, the present invention provides a molded article manufactured by the method as described above.

According to another embodiment, the present invention provides a molded article as described above, wherein the molded article is used for sports related accessories, shoe materials, clothing, automobiles, medical and health care materials, or daily necessities.

The present invention also includes other aspects for solving other problems, which will be combined and disclosed in detail in the following embodiments.

### DETAILED DESCRIPTION OF THE EMBODIMENTS

The preferred embodiments of the present invention will be demonstrated below. In order to avoid obscuring the content of the present invention, the following description also omits conventional components, related materials, and related processing techniques thereof.

Measuring Process of Various Characteristics of the Present Invention

The vinyl aromatic monomer content of the vinyl aromatic based block copolymer: measured with a nuclear magnetic resonance analyzer, which is a measurement method well known to those skilled in the art.

The weight average molecular weight of vinyl aromatic based block copolymer: measured by gel permeation chromatography, which is a measurement method well known to those skilled in the art.

The weight average molecular weight of styrene block: measured by gel permeation chromatography, which is a measurement method well known to those skilled in the art.

Hardness (shore A): measured according to ASTM D2240 standard.

Hardness (shore OO): measured according to ASTM D2240 standard.

Melt Flow Index (MFI): measured according to ASTM D1238 standard.

The present invention provides a polymer composition for 3D printing which comprises a polymer. The polymer includes a vinyl aromatic based block copolymer. The vinyl aromatic based block copolymer has the vinyl aromatic monomer content of less than 25 wt %. The polymer of the present invention refers to a molecule with a weight average molecular weight greater than 10,000 formed by multiple structural units (or called monomers) connected by covalent bonds. To avoid the compatibility issue, the polymer does not contain polyolefin, polylactide, polycarbonate, polyamide, polymethylmethacrylate, poly(methyl acrylate), polyvinylchloride, poly(vinylidene chloride), polyester, vinyl acetate copolymer and styrene-based resin. The styrene-based resin of the present invention is different from the vinyl aromatic based block copolymer. The styrene-based resin is, for example, polystyrene (PS), styrene-acrylonitrile copolymer (SAN), or acrylonitrile-butadiene-styrene copolymer (ABS).

Vinyl Aromatic Based Block Copolymer

The polymer of the present invention mainly comprises the vinyl aromatic based block copolymer, which can be triblock, tetrablock or pentablock. The monomers of the vinyl aromatic based block copolymer are vinyl aromatic monomer and conjugated diene monomer. The conjugated diene monomer suitable for the present invention can be a conjugated diene containing 4 to 12 carbon atoms. Specific examples of the conjugated diene monomer include: 1,3-butadiene, 1,3-pentadiene, 1,3-hexadiene, 1,3-heptadiene, 2-methyl-1,3-butadiene (isoprene), 2-methyl-1,3-pentadiene, 2-hexyl-1,3-butadiene, 2-phenyl-1,3-butadiene, 2-phenyl-1,3-pentadiene, 2-p-tolyl-1,3-butadiene, 2-benzyl-1,3-butadiene, 3-methyl-1,3-pentadiene, 3-methyl-1,3-hexadiene, 3-butyl-1,3-octadiene, 3-phenyl-1,3-pentadiene, 4-methyl-1,3-pentadiene, 1,4-diphenyl-1,3-butadiene, 2,3-dimethyl-1,3-butadiene, 2,3-dimethyl-1,3-pentadiene, 2,3-dibenzyl-1,3-butadiene, 4,5-diethyl-1,3-octadiene, myrcene and any combination thereof, among which 1,3-butadiene and isoprene are the preferred options. Specific examples of the vinyl aromatic monomer suitable for the present invention include: styrene, methyl styrene and all its isomers, ethyl styrene and all its isomers, tert-butyl styrene and all its isomers, dimethyl styrene and all its isomers, methoxystyrene and all its isomers, cyclohexyl styrene and all its isomers, vinyl biphenyl, 1-vinyl-5-hexylnaphthalene, vinyl naphthalene, vinyl anthracene, 2,4-diisopropylstyrene, 5-tert-butyl-2-methylstyrene, divinylbenzene, trivinylbenzene, divinylnaphthalene, tert-butoxystyrene, 4-propylstyrene, 4-dodecylstyrene, 2-ethyl-4-benzylstyrene, 4-(phenylbutyl)styrene, N-4-vinylphenyl-N,N-dimethylamine, (4-vinyl phenyl) dimethylaminoethyl ether, N,N-dimethylaminomethylstyrene, N,N-dimethylaminoethylstyrene, N,N-diethylaminomethylstyrene, N,N-diethylaminoethylstyrene, vinyl xylene, vinyl pyridine, diphenyl ethylene, 2,4,6-trimethylstyrene, α-methyl-2,6-dimethylstyrene, α-methyl-2,4-dimethylstyrene, 6-methyl-2,6-dimethylstyrene, β-methyl-2,4-dimethylstyrene, indene, diphenylethylene containing a tertiary amino group such as 1-(4-N,N-dimethylaminophenyl)-1-phenylethylene and any combination thereof, among which styrene is the preferred option. The vinyl aromatic based block copolymer can be an unhydrogenated copolymer, a partially hydrogenated copolymer (the hydrogenation rate of unsaturated double bonds of the conjugated diene monomer is 10 to 90%), or a fully hydrogenated copolymer (the hydrogenation rate of unsaturated double bonds of the conjugated diene monomer is greater than 90%). Preferred examples of the hydrogenated vinyl aromatic based block copolymers are Styrene-Ethylene-Butylene-Styrene block copolymer (SEBS), Styrene-Ethylene-Propylene-Styrene block copolymer (SEPS), Styrene-Ethylene-Ethylene-Propylene-Styrene block copolymer (SEEPS) and various combinations thereof. Preferred examples of the unhydrogenated vinyl aromatic based block copolymer are Styrene-Butadiene-Styrene block copolymer (SBS), Styrene-Isoprene-Styrene block copolymer (SIS), Styrene-(Isoprene/Butadiene)-Styrene block copolymer (S-(I/B)-S) and various combinations thereof. Preferably, the vinyl aromatic based block copolymer is selected from SEBS, SEEPS, SEPS, SIS, SBS, S-(I/B)-S and various combinations thereof.

In one preferred embodiment, in the polymer composition of the present invention, the polymer includes only the vinyl aromatic based block copolymer and no polymer other than the vinyl aromatic based block copolymer. In this type of polymer composition, for example, the polymer can be one or more of SEBS, SEEPS, SEPS, SIS, SBS, S-(I/B)-S, and no polymer other than the vinyl aromatic based block copolymer is present. In another preferred embodiment, the polymer can be a combination of a variety of SEBS with different styrene content, and no polymer other than the vinyl aromatic based block copolymer is present.

In one preferred embodiment, the weight average molecular weight of the vinyl aromatic based block copolymer is in the range of 50,000 to 500,000, preferably 70,000 to 350,000; and the weight average molecular weight of the vinyl aromatic block of the vinyl aromatic based block copolymer ranges from 4,000 to 7,000, preferably 6,000 to 7,000, more preferably 4,000 to 5,000, and most preferably 5,200 to 5,800. If SBS is used in the polymer composition, the weight average molecular weight of the styrene block is in the range of 5,000 to 6,000; and if SEBS is used in the polymer composition, the weight average molecular weight of the styrene block is in the range of 4,000 to 7,000.

Processing Aid

In one preferred embodiment, the polymer composition of the present invention includes a processing aid. In one preferred embodiment, the weight ratio of the vinyl aromatic based block copolymer to the processing aid in the polymer composition of the present invention is 1:0 to 1:4, preferably 1:1 to 1:4. In one preferred embodiment, the content of the processing aid is not greater than four times the content of the vinyl aromatic based block copolymer. In one preferred embodiment, the content of the processing aid is 50 to 80% by weight, preferably 55 to 75% by weight, more preferably 60 to 75% by weight, and most preferably 65% to 75% by weight, of the total weight of the polymer composition. The polymer composition containing the processing aid of the present invention can be used for printing at a temperature lower than 200° C., preferably lower than 150° C. Printing at a temperature lower than 200° C. can reduce energy consumption and the generation of odor. The processing aid is selected from processing oil, tackifier, plasticizer and melt strength enhancer. The processing oil may be paraffin oil, naphthenic oil, aromatic hydrocarbon oil and various combinations thereof. The tackifier can be rosin resin, petroleum based resin, terpene resin or an oligomer, in which the oligomer is formed by the polymerization of many identical or different structural units and has a weight average molecular weight of less than 10,000. Preferably, the oligomer is formed by polymerization of ethylene, butene, styrene or various combinations of the above monomers. The plasticizer is an additive that increases the flexibility of the material or makes the material liquefy. The plasticizer is a fatty oil-based plasticizer or an epoxidized oil-type plasticizer. The fatty oil-based plasticizer is glycerin, castor oil, soybean oil or zinc stearate. The epoxidized oil-type plasticizer is epoxidized soybean oil or epoxidized linseed oil. The melt strength enhancer is an additive that increases the melt strength of materials. The melt strength enhancer is a fluorine-containing compound, among which polytetrafluoroethylene (PTFE) is preferred.

In one preferred embodiment, the polymer composition of the present invention includes an auxiliary agent. This auxiliary agent is different from the processing aid. For example, the auxiliary agent may be a colorant, a filler to increase strength, or other auxiliary agents that has functions different from that of the processing aid. The colorant can be selected from color powder and color masterbatch. The filler can be any suitable inorganic filler, such as talcum powder, gypsum powder, asbestos powder, potter's clay, clay, mica powder, kaolin, carbon, calcium carbonate, magnesium carbonate, barium sulfate, magnesium sulfate, aluminum oxide, silicon oxide, magnesium oxide, iron oxide, titanium oxide, zinc oxide, tin oxide, silicon nitride, aluminum nitride, calcium silicate, aluminum silicate, zirconium silicate, etc. The inorganic fillers can be used alone or in combination of multiple types. Other auxiliary agent may be, for example, an antioxidant.

The present invention also has examples that do not contain the processing aid or the auxiliary agent. A preferred example of this type is the polymer composition having the aforementioned vinyl aromatic based block copolymer only and no other component is contained. For details, please refer to the subsequent examples.

Material for 3D Printing

According to the polymer composition described above, the present invention provides a material suitable for 3D printing, which is a blended material formed by blending materials selected from the polymer composition described above before it can enter the 3D printing machine. Such a blended material can be in the form of pellet, powder, thread or filament. In one preferred embodiment, the polymer composition of such a blended material includes the processing aid and the vinyl aromatic based block copolymer. For example, the polymer composition contains the vinyl aromatic based block copolymer with a single specification and the processing aid; the polymer composition contains the vinyl aromatic based block copolymers with more than two specifications and the processing aid, such as the polymer composition containing two kinds of SEBS with different styrene content and the processing aid; or the polymer composition containing SEBS, SEEPS and the processing aid. Since such a blended material contains the processing aid, it can be injected to form a test piece with the hardness of less than or equal to 20 (shore A), preferably less than or equal to 15 (shore A), and more preferably less than or equal to 5 (shore A). In another preferred embodiment, the polymer composition of such a blended material does not contain the processing aid, and more preferably contains only the vinyl aromatic based block copolymer. For example, the polymer composition contains the vinyl aromatic based block copolymers with more than two specifications, such as the polymer composition containing two kinds of SEBS with different styrene content; or the polymer composition containing SEBS and SEEPS. Since such a blended material does not contain the processing aid, it can be injected to form a test piece with the hardness of less than or equal to 70 (shore A), preferably between 35 and 70 (shore A).

According to the polymer composition described above, the present invention provides a material suitable for 3D printing, which is selected from the polymer composition described above and can directly enter the 3D printing machine for printing without blending. Preferably, such a polymer composition does not contain the aforementioned processing aid, and more preferably does not contain the processing oil. More preferably, the polymer composition of such a material only contains the polymer, such as one of many types of vinyl aromatic based block copolymers, and has a specific specification. Such a material can be in pellet, powder, thread or filament form and may contain an antioxidant or other auxiliary agents that need to be added during the process (polymerization, modification or hydrogenation) for manufacturing this polymer (that is, the vinyl aromatic based block copolymer). In one preferred embodiment, the material can be injected to form a test piece having the hardness of less than or equal to 70 (shore A), preferably between 35 and 70 (shore A).

Method for Manufacturing a Molded Article by 3D Printing

The 3D printing material described above can be used to produce a molded article by any suitable 3D printing machine.

In one embodiment, the Fused Deposition Modeling (FDM) method is used for printing. For example, the method includes providing a software to construct a 3D model diagram of an article; inputting the 3D model diagram into a printing machine; feeding the material described above into a die head of the printing machine and heating the material into a molten state; and extruding the material in the molten state through a printing head, followed by cooling and stacking layer upon layer to form a steromolded article.

In one embodiment, the Multi Jet Fusion (MJF) method is used for printing. For example, the method includes providing a software to construct a 3D model diagram of an article; inputting the 3D model diagram into a printing machine; spreading the material described above on a platform; spraying a melting agent on an area to be formed; irradiating the material into a molten state in the printing machine using a high-power energy source and adhesively agglomerating into blocks; and spreading another layer of material on the blocks and continuing a manufacturing process of a next layer until the article is formed.

In one embodiment, the Selective Laser Sintering (SLS) method is used for printing. For example, the method includes providing a software to construct a 3D model diagram of an article; inputting the 3D model diagram into a printing machine; spreading the material described above on a platform; controlling a laser irradiation position in the printing machine using a computer; irradiating the material into a molten state by laser light and adhesively agglomerating into blocks; and spreading another layer of material on the blocks and continuing a manufacturing process of a next layer until the article is formed.

The process, features, and advantages of the present invention will be further illustrated in the following preferred embodiments, which are not used to limit the scope of the present invention. The scope of the present invention should be subject to the appended claims.

Various chemical components used in some Examples or Comparative Examples of the present invention are described below.

SEBS 6014: TSRC Corporation, with the styrene content of 18 wt %, the weight average molecular weight of 90,000 to 100,000, and the styrene block molecular weight of 5,200 to 5,800.

SEBS 6052: TSRC Corporation, with the styrene content of 23 wt %, the weight average molecular weight of 60,000 to 75,000, and the styrene block molecular weight of 4,000 to 5,000.

SEBS 6245: TSRC Corporation, with the styrene content of 12 wt %, the weight average molecular weight of 130,000 to 160,000, and the styrene block molecular weight of 6,000 to 7,000.

SEBS 6154: TSRC Corporation, with the styrene content of 30 wt %, the weight average molecular weight of 165,000-175,000, and the styrene block molecular weight of 37,000-43,000.

SEEPS 7311: Kuraray Company, with the styrene content of 12 wt %.

SEEPS 4033: Kuraray Company, with the styrene content of 30 wt %.

SEPS 7125F: Kuraray Company, with the styrene content of 20 wt %.

SBS 6014: TSRC Corporation, with the styrene content of 17.7 wt %, the weight average molecular weight of 90,000 to 100,000, and the styrene block molecular weight of 5,200 to 5,800.

SIS 4111: TSRC Corporation, with the styrene content of 18 wt % and the weight average molecular weight of 170,000 to 175,000.

Oil 150N: base oil, Ssangyong Oil Refining Company of SK Group in South Korea.

PS-PG33: Polystyrene, Chi Mei Corporation.

PP-1352: Polypropylene, Formosa Plastics Corporation.

### Example 1

20 wt % of the polymer SEBS 6014 (styrene content 18 wt %) and 80 wt % of the processing aid Oil 150N were taken as the polymer composition. The polymer composition was blended and pelletized at 160-230° C. using a twin screw extruder to obtain blended pellets. The blended pellets were injected to form a test piece in plate form and the hardness thereof was measured. After the blended pellets were placed to stabilize for 1 day, the MFI value was measured, and then the printing feasibility analysis was performed for the FDM process using pellet feed (140° C.).

All the polymer compositions of Examples 1 to 8 and Comparative Example 1 use SEBS and Oil 150N as the components. Refer to Table 1 for the components of the polymer compositions of these examples. Refer to Example 1 for the practice of these examples.

TABLE 1

| Polymer | | | | | | | | | Comp. |
|---|---|---|---|---|---|---|---|---|---|
| composition (wt %) | Ex. 1 | Ex. 2 | Ex. 3 | Ex. 4 | Ex. 5 | Ex. 6 | Ex. 7 | Ex. 8 | Ex. 1 |
| SEBS 6014 (BS = 18) | 20 | 27 | 33 | 40 | 50 | | | 16.5 | |
| SEBS 6052 (BS = 23) | | | | | | 33 | | | |
| SEBS 6245 (BS = 12) | | | | | | | 33 | 16.5 | |
| SEBS 6154 (BS = 30) | | | | | | | | | 40 |
| Oil 150N | 80 | 73 | 67 | 60 | 50 | 67 | 67 | 67 | 60 |

Physical properties

| | | | | | | | | | |
|---|---|---|---|---|---|---|---|---|---|
| Hardness (shore A) | <1 | 5 | 10 | 15 | 18 | 5 | <1 | 5 | 25 |
| Hardness (shore OO) | 35 | 45 | 55 | 65 | 68 | 45 | 21 | 44 | 75 |
| MFI(130° C., 2.16 kg) | >800 | 39.61 | 1.51 | 0.71 | <0.1 | >800 | >800 | >800 | <<0.1 |
| (g/10 min) | | | | | | | | | |
| Printable or not(140° C.) | Yes | Yes | Yes | Yes | Yes | Yes | Yes | Yes | No (X) |

The following explains the meaning of the symbols in the table of the present invention. X means that it is not printable, that is, the material cannot be smoothly extruded from the print nozzle, so the material cannot be layered on the printing substrate. MFI<0.1 means that the material can flow out of the die of the MFI machine, but the data is less than 0.1. MFI<<0.1 means that the material cannot flow out of the die of the MFI machine.

Referring to Table 1, Examples 1 to 8 show that the polymer compositions are successful printed, and the styrene content of SEBS (vinyl aromatic monomer content, represented by BS in the table) is less than 25% by weight. Table 1 also shows that in the polymer compositions of Examples 1 to 8, the weight ratios of SEBS to Oil 150N are in the range of 1:1 to 1:4. The present invention also has a comparative example (not shown in the table), in which the weight of the processing aid is more than four times the weight of the vinyl aromatic based block copolymer (SEBS). This comparative example cannot be processed and blended as it has too much oil exceeding the limit of absorbable oil amount of SEBS. In addition, Table 1 also shows that under the same oil percentage as in Example 4, Comparative Example 1 cannot achieve printing due to the high styrene content of SEBS (over 25 wt %). Examples 1 to 8 were successfully printed, and the hardness (shore A) of the test pieces formed respectively by injecting the blended materials made from the polymer compositions thereof were measured to be not greater than 20.

The polymer compositions of Examples 9 to 11 are composed of one polymer selected from SEEPS, SBS, and SIS, as well as the processing aid Oil 150N. Refer to Example 1 for the practice of these examples. Refer to Table 2 for the components of the polymer compositions of these examples.

TABLE 2

| Polymer composition (wt %) | Ex. 9 | Ex. 10 | Ex. 11 |
|---|---|---|---|
| SEEPS 7311 (BS = 12) | 40 | | |
| SBS 6014 (BS = 17.7) | | 40 | |
| SIS 4111 (BS = 18) | | | 40 |
| Oil 150N | 60 | 60 | 60 |

Physical properties

| | | | |
|---|---|---|---|
| Hardness (shore A) | <1 | 2 | <1 |
| Hardness (shore OO) | 12 | 39 | 18 |
| MFI(130° C., 2.16 kg) | 272 | 469 | >800 |
| (g/10 min) | | | |
| Printable or not((140° C.) | Yes | Yes | Yes |

Referring to Table 2, Examples 9 to 11 show that the polymer compositions are successful printed, and the styrene content of SEEPS/SBS/SIS is less than 25% by weight. Table 2 also shows that in the polymer compositions of Examples 9 to 11, the weight ratio of SEEPS/SBS/SIS to Oil 150N is in the range of 1:1 to 1:4. The present invention also has a comparative example (not shown in the table), in which the weight of the processing aid is more than four times the weight of the vinyl aromatic based block copolymer (SEEPS/SBS/SIS). This comparative example cannot be processed and blended as it has too much oil exceeding the limit of absorbable oil amount of SEEPS/SBS/SIS. Examples 9 to 11 were successfully printed, and the hardness (shore A) of the test pieces formed by injecting the blended materials made from the polymer compositions thereof were measured to be not greater than 5.

### Example 12

50 wt % of the polymer SEBS 6014 (styrene content 18 wt %) and 50 wt % of SEBS 6245 (styrene content 12 wt %) were taken as the polymer composition. The polymer composition was blended and pelletized at 160-230° C. using a twin screw extruder to obtain blended pellets. The blended pellets were injected to form a test piece in plate form and the hardness thereof was measured. After the blended pellets were placed to stabilize for 1 day, the MFI value was measured, and then the printing feasibility analysis was performed for the FDM process using pellet feed (240° C.).

### Example 13

100 wt % of the polymer SEBS 6014 (styrene content 18 wt %) was taken as the polymer composition. The polymer composition was injected to form a test piece in plate form and the hardness thereof was measured. The polymer composition was measured for the MFI value, and then the printing feasibility analysis was performed for the FDM process using pellet feed (240° C.).

All the polymer compositions of Examples 12 to 15 and Comparative Example 2 are SEBS. Refer to Example 13 for the practice of Examples 14 to 18 and Comparative Examples 2 to 3. Refer to Table 3 for the components of the polymer compositions of Examples 12 to 18 and Comparative Examples 2 to 3.

TABLE 3

| Polymer | | | | | Comp. | | Comp. | | |
|---|---|---|---|---|---|---|---|---|---|
| composition (wt %) | Ex. 12 | Ex. 13 | Ex. 14 | Ex. 15 | Ex. 2 | Ex. 16 | Ex. 3 | Ex. 17 | Ex. 18 |
| SEBS 6014 (BS = 18) | 50 | 100 | | | | | | | |
| SEBS 6052 (BS = 23) | | | 100 | | | | | | |
| SEBS 6245 (BS = 12) | 50 | | | 100 | | | | | |
| SEBS 6154 (BS = 30) | | | | | 100 | | | | |
| SEEPS 7311 (BS = 12) | | | | | | 100 | | | |
| SEEPS 4033 (BS = 30) | | | | | | | 100 | | |
| SEPS 7125F (BS = 20) | | | | | | | | 100 | |
| SIS 4111 (BS = 18) | | | | | | | | | 100 |

Physical properties

| | | | | | | | | | |
|---|---|---|---|---|---|---|---|---|---|
| Hardness (shore A) | 50 | 60 | 66 | 40 | 76 | 41 | 76 | 64 | 40 |
| MFI(230° C., 2.16 kg) | 5.43 | 5.81 | 50.42 | 3.91 | <<0.1 | 2.02 | <<0.1 | 4 | 17.78 |
| (g/10 min) | | | | | | | | | |
| Printable or not (240° C.) | Yes | Yes | Yes | Yes | No | Yes | No | Yes | Yes |

Referring to Table 3, Examples 12 to 18 are examples that the polymer composition without addition of oil can achieve printing. Example 12 is a polymer composition formed by blending two kinds of SEBS without addition of oil, in which both the two kinds of SEBS have a styrene content of less than 25% by weight. Unlike Examples 13 to 18, the polymer composition of Example 12 requires further blending to form the blended material before it can enter the 3D printing machine for printing. Example 12 was successfully printed, and the hardness (shore A) of the test piece formed by injecting the blended material made from the polymer composition of Example 12 was measured to be not greater than 70. Examples 13 to 18 show that those polymers SEBS/SEEPS/SEPS/SIS having the styrene content of less than 25% by weight can directly enter the 3D printing machine to complete printing. Both the polymer SEBS of Comparative Example 2 and the polymer SEEPS of Comparative Example 3 have the styrene content greater than 25% by weight and cannot be printed. Examples 13 to 18 were successfully printed, and the hardness (shore A) of the test pieces formed by injecting the polymer compositions was measured to be not greater than 70. In addition, compared to Examples 1 to 12 that required further blending to form blended materials before entering the 3D printing machine for printing, Examples 13 to 18 of Table 3 have the advantage of simple processing procedures.

As to the polymer compositions of Comparative Examples 4-7, in addition to SEBS and Oil 150N, polystyrene (PS) or polypropylene (PP) was further added to the compositions. Refer to Example 1 for the practice of Comparative Examples 4-7. Refer to Table 4 for the components of the polymer compositions of Comparative Examples 4-7.

TABLE 4

| Polymer | | Comp. | Comp. | | Comp. | Comp. |
|---|---|---|---|---|---|---|
| composition (wt %) | Ex. 4 | Ex. 4 | Ex. 5 | Ex. 8 | Ex. 6 | Ex. 7 |
| SEBS 6014 (BS = 18) | 40 | 36 | 36 | 16.5 | 14.85 | 14.85 |
| SEBS 6245 (BS = 12) | | | | 16.5 | 14.85 | 14.85 |
| PS-PG33 | | 10 | | | 10 | |
| PP-1352 | | | 10 | | | 10 |
| Oil 150N | 60 | 54 | 54 | 67 | 60.3 | 60.3 |

Physical properties

| | | | | | | |
|---|---|---|---|---|---|---|
| Hardness (shore A) | 15 | 18 | 18 | 5 | 6 | 7 |
| Hardness (shore OO) | 65 | 69 | 68 | 43 | 51 | 53 |
| Printable or not (200° C.) | Yes | Yes | Yes | Yes | Yes | Yes |

Referring to Table 4, compared with Comparative Examples 4-5 with the addition of PS/PP, Example 4 without addition of PS/PP had better softness characteristics. Compared with Comparative Examples 6-7 with the addition of PS/PP, Example 8 without addition of PS/PP had better softness characteristics.

Although the present invention has been disclosed in the above preferred embodiments, it is not intended to limit the invention, and it is possible for those skilled in the art to make alterations and modifications without departing from the spirit and scope of the invention. Therefore, the scope of the invention is defined by the appended claims.

1. A polymer composition for 3D printing, comprising:
a polymer, including a vinyl aromatic based block copolymer composed of a vinyl aromatic monomer and a conjugated diene monomer, and the vinyl aromatic based block copolymer has a vinyl aromatic monomer content of less than 25 wt %, wherein the polymer does not contain a polyolefin, a polylactide, a polycarbonate, a polyamide, a polymethylmethacrylate, a poly(methyl acrylate), a polyvinylchloride, a polyvinylidene chloride, a polyester, a vinyl acetate copolymer and a styrene-based resin.

2. The polymer composition of claim 1, wherein the vinyl aromatic monomer is selected from styrene, methyl styrene and all its isomers, ethyl styrene and all its isomers, tert-butyl styrene and all its isomers, dimethyl styrene and all its isomers, methoxystyrene and all its isomers, cyclohexyl styrene and all its isomers, vinyl biphenyl, 1-vinyl-5-hexylnaphthalene, vinyl naphthalene, vinyl anthracene, 2,4-diisopropylstyrene, 5-tert-butyl-2-methylstyrene, divinylbenzene, trivinylbenzene, divinylnaphthalene, tert-butoxystyrene, 4-propylstyrene, 4-dodecylstyrene, 2-ethyl-4-benzylstyrene, 4-(phenylbutyl)styrene, N-4-vinylphenyl-N,N-dimethylamine, (4-vinyl phenyl) dimethylaminoethyl ether, N,N-dimethylaminomethylstyrene, N,N-dimethylaminoethylstyrene, N,N-diethylaminomethylstyrene, N,N-diethylaminoethylstyrene, vinyl xylene, vinyl pyridine, diphenyl ethylene, 2,4,6-trimethylstyrene, α-methyl-2,6-dimethylstyrene, α-methyl-2,4-dimethylstyrene, β-methyl-2,6-dimethylstyrene, β-methyl-2,4-dimethylstyrene, indene, diphenylethylene containing a tertiary amino group, 1-(4-N,N-dimethylaminophenyl)-1-phenylethylene and a combination thereof; and the conjugated diene monomer is selected from 1,3-butadiene, 1,3-pentadiene, 1,3-hexadiene, 1,3-heptadiene, 2-methyl-1,3-butadiene (isoprene), 2-methyl-1,3-pentadiene, 2-hexyl-1,3-butadiene, 2-phenyl-1,3-butadiene, 2-phenyl-1,3-pentadiene, 2-p-tolyl-1,3-butadiene, 2-benzyl-1,3-butadiene, 3-methyl-1,3-pentadiene, 3-methyl-1,3-hexadiene, 3-butyl-1,3-octadiene, 3-phenyl-1,3-pentadiene, 4-methyl-1,3-pentadiene, 1,4-diphenyl-1,3-butadiene, 2,3-dimethyl-1,3-butadiene, 2,3-dimethyl-1,3-pentadiene, 2,3-dibenzyl-1,3-butadiene, 4,5-diethyl-1,3-octadiene, myrcene and a combination thereof.

3. The polymer composition of claim 1, wherein the vinyl aromatic based block copolymer is an unhydrogenated copolymer, a partially hydrogenated copolymer, or a fully hydrogenated copolymer.

4. The polymer composition of claim 1, wherein the vinyl aromatic based block copolymer is selected from Styrene-Ethylene-Butylene-Styrene block copolymer (SEBS), Styrene-Ethylene-(Ethylene-Propylene)-Styrene block copolymer (SEEPS), Styrene-Ethylene-Propylene-Styrene block copolymer (SEPS), Styrene-Butadiene-Styrene block copolymer (SBS), Styrene-Isoprene-Styrene block copolymer (SIS), Styrene-(Isoprene/Butadiene)-Styrene block copolymer (S-(I/B)-S) and a combination thereof.

5. The polymer composition of claim 1, wherein the polymer consists of the vinyl aromatic based block copolymer.

6. The polymer composition of claim 1, wherein the weight average molecular weight of the vinyl aromatic based block copolymer ranges from 50,000 to 500,000, preferably 70,000 to 350,000.

7. The polymer composition of claim 1, further comprising a processing aid, wherein the content of the processing aid is not greater than four times the content of the vinyl aromatic based block copolymer.

8. The polymer composition of claim 7, wherein the processing aid is selected from processing oils, which are aromatic hydrocarbon oil, naphthenic oil, paraffin oil and a combination thereof.

9. The polymer composition of claim 7, wherein the content of the processing aid is 50 to 80 wt %, preferably 55 to 75 wt %, more preferably 60 to 75 wt %, and most preferably 65 to 75 wt % of the total weight of the polymer composition.

10. The polymer composition of claim 1, wherein the polymer composition does not contain a processing aid.

11. The polymer composition of claim 1, further comprising an auxiliary agent, wherein the auxiliary agent is selected from a colorant, an inorganic filler, an antioxidant and a combination thereof.

12. A material for 3D printing made from the polymer composition of claim 1.

13. The material of claim 12, having a pellet, powder, thread or filament form.

14. The material of claim 12, wherein a test piece formed by injecting the material has the hardness of less than or equal to 70 (shore A), preferably 35 to 70 (shore A), measured according to the ASTM-D2240 method.

15. The material of claim 12, wherein a test piece formed by injecting the material has a hardness of less than or equal to 20 (shore A), preferably less than or equal to 15 (shore A), more preferably less than or equal to 5 (shore A), measured according to the ASTM-D2240 method.

16. A method for 3D printing, comprising:
step (1): providing the material of claim 12; and
step (2): 3D printing the material.

17. The method of claim 16, wherein the step (2) further comprises using Fused Deposition Modeling (FDM) for the 3D printing.

18. The method of claim 16, wherein the step (2) further comprises using Selective Laser Sintering (SLS) for the 3D printing.

19. The method of claim 16, wherein the step (2) further comprises using Multi Jet Fusion (MJF) for the 3D printing.

20. The method of claim 16, wherein the step (2) further comprises printing at a temperature of lower than 250° C., preferably between 230° C. and 250° C.

21. The method of claim 16, wherein the step (2) further comprises printing at a temperature of lower than 200° C., preferably between 130° C. and 150° C.

22. A molded article manufactured from the material of claim 12 by 3D printing.

23. A molded article manufactured by the method of claim 16.

24. The molded article of claim 22, wherein the molded article is used in sports related accessories, shoe materials, clothing, automobiles, medical and health care materials, or daily necessities.
